(19) United States
(12) Patent Application Publication
(10) Pub. No.: US 2026/0085774 A1
(43) Pub. Date: Mar. 26, 2026

(54) GAP LIMITING COUPLING

(71) Applicant: Victaulic Company, EASTON, PA (US)

(72) Inventor: Eric Frank Finlayson, Stroudsburg, PA (US)

(21) Appl. No.: 19/333,539

(22) Filed: Sep. 19, 2025

Related U.S. Application Data
(60) Provisional application No. 63/697,281, filed on Sep. 20, 2024.

(51) Int. Cl. F16L 17/08; F16L 17/04

(52) U.S. Cl. CPC F16L 17/08; F16L 17/04

(57) ABSTRACT

A ring surrounding a central axis and attachable to an end of a pipe element comprises a forward face extending between a circumferential inner surface that faces the central axis and is adapted to receive the pipe element and a circumferential outer surface that faces away from the central axis. The forward face comprises a first side surface and a sloped surface positioned between the first side surface and the circumferential inner surface. The first side surface and the sloped surface define a pocket within the forward face configured to receive a weld. In a cross-sectional plane including the central axis, the sloped surface extends away from the circumferential inner surface at an obtuse angle. The obtuse angle extends through the ring.

### CROSS REFERENCE TO RELATED APPLICATION

This application is based upon and claims priority to US Provisional Application No. U.S. 63/697,281, filed Sep. 20, 2024, which application is hereby incorporated by reference herein in its entirety.

### FIELD

This disclosure relates to mechanical couplings for joining pipe elements.

### BACKGROUND

Mechanical methods of making connections between pipes and between pipes and piping components often permit or explicitly create a gap between the end faces of the two pipe elements being joined. Certain types of mechanical piping joints may have features which enable the pipe elements to be pulled toward one another in order to reduce this gap. For example, in some mechanical piping joints, collars (e.g., rings) can be welded to the outer surfaces of the pipe elements using filler material or a welding rod positioned at the ends of the collars closest to the pipe ends. However, the weld material that secures such collars to the pipe elements can have an inconsistent profile and can undesirably extend beyond the corresponding end of the pipe element, leading to an inconsistent and/or undesirably large gap between the pipe end faces about the circumference of the pipe. This inconsistency can prevent the pipe elements from forming a joint that operates correctly. Grinding processes can be used to remove the protruding filler material and/or smooth the pipe element faces. However, such processes are undesirably time-consuming, dangerous, and ineffective and can even lead to removal of too much material from the pipe element faces, creating new gaps.

There is clearly an opportunity to create a ring and a method for affixing a ring to pipe elements, which reduces or excludes the likelihood of excess weld filler material from protruding beyond the end faces of the pipe elements to be joined.

### SUMMARY

A ring surrounding a central axis and attachable to an end of a pipe element is disclosed. The ring comprises a circumferential inner surface facing the central axis and adapted to receive the pipe element. A circumferential outer surface faces away from the central axis. A backwall extends between the circumferential inner surface and the circumferential outer surface. A forward face extends between the circumferential inner surface and the circumferential outer surface. The forward face is spaced from the backwall along the central axis. The forward face is closer to the end of the pipe element than the backwall is to the end of the pipe element. The forward face comprises a first side surface and a sloped surface positioned between the first side surface and the circumferential inner surface. The first side surface and the sloped surface define a pocket within the forward face. In a cross-sectional plane including the central axis, the sloped surface extends away from the circumferential inner surface at an obtuse angle. The obtuse angle extends through the ring.

An assembly for joining a first pipe element and a second pipe element in facing end to end relation is also disclosed. The assembly includes the ring disclosed herein.

A combination of a ring surrounding a central axis and a pipe element is disclosed. The pipe element extends along a longitudinal axis and comprises an inner surface facing the longitudinal axis and an outer surface facing away from the longitudinal axis. The ring comprises a circumferential inner surface facing the central axis and adapted to receive the pipe element. A circumferential outer surface faces away from the central axis. A backwall extends between the circumferential inner surface and the circumferential outer surface. A forward face extends between the circumferential inner surface and the circumferential outer surface. The forward face is spaced from the backwall along the central axis. The forward face is closer to the end of the pipe element than the backwall is to the end of the pipe element. The forward face comprises a first side surface and a sloped surface positioned between the first side surface and the circumferential inner surface. The first side surface and the sloped surface defining a pocket within the forward face. In a cross-sectional plane including the central axis, the sloped surface extends away from the circumferential inner surface at an obtuse angle. The obtuse angle extends through the ring.

A method of affixing a ring surrounding a central axis to an end of a pipe element is disclose. The pipe element extends along a longitudinal axis and comprises an inner surface facing the longitudinal axis and an outer surface facing away from the longitudinal axis. The ring comprises a circumferential inner surface facing the central axis and adapted to receive the pipe element. A circumferential outer surface faces away from the central axis. A backwall extends between the inner surface and the outer surface. A forward face extends between the inner surface and the outer surface. The forward face is spaced from the backwall along the central axis. The forward face is closer to the end of the pipe element than the backwall is to the end of the pipe element. The forward face comprises a first side surface and a sloped surface positioned between the first side surface and the circumferential inner surface. The first side surface and the sloped surface defines a pocket within the forward face. The method comprises welding the ring to the outer surface of the pipe element within the pocket.

### BRIEF DESCRIPTION OF THE DRAWINGS

FIG. 1 is an isometric view of an example assembly according to the disclosure, the assembly shown joining pipe elements with a coupling;

FIG. 2 is an isometric view of an example assembly according to the disclosure, the assembly shown joining pipe elements via flanges that are coupled together by fasteners;

FIG. 3 is an end view of the example assembly shown in FIG. 1;

FIG. 4 is a cross section view taken along a portion of a plane indicated by section lines 3-3 in FIG. 2;

FIG. 5 is an isometric view of an example ring according to the disclosure as mounted to a pipe element;

FIG. 6 is an isometric view of an example ring according to the disclosure as mounted to a pipe element;

FIG. 7 is an isometric view of an example ring according to the disclosure as mounted to a pipe element;

FIG. 8 is a cross section view through a portion of the example ring and pipe as shown in FIG. 6 along a plane including the central axis;

and

FIG. 9 is a cross section view through a portion of the example ring and pipe as shown in FIG. 7 along a plane including the central axis.

### DETAILED DESCRIPTION

The present disclosure can be understood more readily by reference to the accompanying detailed description, which includes examples, claims and drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout. It is to be understood that this invention is not limited to the particular methodology and protocols described, as such may vary. It is also to be understood that the terminology used herein is for the purpose of describing particular embodiments only, and is not intended to limit the scope of the present invention.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

As used herein the singular forms “a,” “an,” and “the” can optionally include plural referents unless the context clearly dictates otherwise. For example, use of the term “a channel” can represent disclosure of embodiments in which only a single channel is provided, and unless the context dictates otherwise, can also represent disclosure of embodiments in which a plurality of such channels are provided.

All technical and scientific terms used herein have the same meaning as commonly understood to one of ordinary skill in the art to which this invention belongs unless clearly indicated otherwise.

As used herein, the terms “optional” or “optionally” mean that the subsequently described event or circumstance may or may not occur, and that the description includes instances where said event or circumstance occurs and instances where it does not.

As used herein, the term “at least one of” is intended to be synonymous with “one or more of.” For example, “at least one of A, B and C” explicitly includes only A, only B, only C, and combinations of each (e.g., A and B, A and C, B and C, or A, B, and C).

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. Optionally, in some aspects, when values are approximated by use of the antecedent “about,” it is contemplated that values within up to 15%, up to 10%, up to 5%, or up to 1% (above or below) of the particularly stated value can be included within the scope of those aspects. Similarly, use of “substantially” (e.g., “substantially parallel”) or “generally” (e.g., “generally planar”) should be understood to include embodiments in which angles are within ten degrees, or within five degrees, or within one degree of the stated position or orientation.

The word “or” as used herein means any one member of a particular list and, in alternative embodiments, unless context dictates otherwise, can include any combination of members of that list.

It is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

The following description supplies specific details in order to provide a thorough understanding. Nevertheless, the skilled artisan would understand that the device, systems, and associated methods can be implemented and used without employing these specific details. Indeed, the device, systems, and associated methods can be placed into practice by modifying the illustrated device, systems, and associated methods and may be used in conjunction with any other apparatus and techniques conventionally used in the industry.

### INTRODUCTION

Mechanical methods of making connections between pipes and between pipes and piping components often permit or explicitly create a gap between the end faces of the two pipe elements being joined. In some industries (especially mining) the media transported in the pipeline (such as slurries) may be abrasive and/or corrosive and can cause accelerated wear on the interior portions of the pipe. Areas within the pipeline that protrude into, or otherwise alter or obstruct, the flow of such media may be particularly susceptible to accelerated wear from that flowing media. Where pipelines are joined with mechanical connections, the gaps between the facing ends of the two pipe elements being joined may create a flow disturbance that exposes the ends of the pipe within the joint to accelerated wear. Further, the gaps may be large enough (or, with wear to the ends of the pipes, become large enough) to allow media to enter into the gap where it can harden or potentially reach and affect the seal which is often on the outer surface of the pipe elements. Certain types of mechanical piping joints may have features which enable the pipe elements to be pulled toward one another in order to reduce this gap.

In large diameter pipelines of the kind commonly used in mining applications, large collars in the form of annular rings are affixed (commonly by welding) to the outer surface of the pipes near the ends of the pipe to better enable the use of couplings or flanges to join the pipe elements one to another. To accommodate the anticipated loads on the piping system, these rings may be welded to the pipe elements using a weld at the front of the ring (near the end of the pipe element to be joined) that goes circumferentially around the pipe and ring, and at the rear of the ring (opposite the end of the pipe element to be joined). Welding operations for the loads that are expected to be accommodated may employ filler material (or welding rod) that is added to the joint, rather than merely melting and amalgamating the two components to one other. Regardless of the amount of care employed in the welding process, the circumferential weld that is located at the front of the ring is commonly built up with filler material beyond the end of the pipe element. As this buildup does not protrude consistently from the pipe end face about the circumference of the pipe, it inhibits the ability of the pipe elements to be brought together with zero or minimal gap, and, instead, creates a varying gap between the pipe end faces about the circumference of the pipe. In cases where mechanical couplings or flanges act to bring the pipe end faces together to reduce or eliminate the gap are intended to be employed, this varying protrusion of weld filler material may affect the joint. In such circumstances, as a further operation after welding, installers may use powered handheld grinders to attempt to remove protruding filler material and grind the end faces of the pipe element and the rings smooth so that the couplings can bring them together in facing engagement. However, this additional operation is dangerous, takes significant time, and, given that it is being performed under field conditions, is limited in its ability to make the surfaces flat and parallel all about the circumference of pipe elements that may be well over 24 inches in diameter. These grinding operations can even remove too much material in certain locations, creating new gaps.

The ring disclosed herein comprises a pocket in the front face of the ring. The pocket may allow the ring to be welded to a pipe element along the front face without the weld protruding beyond the front face of the ring and the end face of the pipe element. Advantageously, the ring may comprise an outer surface that is configured to allow the ring affixed to the pipe element to be joined with another pipe element. Optionally, the outer surface may comprise a groove configured to receive an arcuate key of a coupling to join the ring affixed to the pipe element with another pipe element. In this example, an assembly for joining two pipe elements in end to end facing engagement may comprise the ring comprising an outer surface including a groove and a mechanical coupling for joining the pipe element to another grooved pipe element or grooved ring affixed to the other pipe element. Alternatively, the outer surface may comprise a flange portion configured to interface with another flange of a pipe element. In this example, an assembly for joining two pipe elements in end to end facing engagement may comprise the ring comprising an outer surface including a flange portion and another flanged pipe element or ring with a flange affixed to the other pipe element.

As further explained herein, the disclosed rings, assemblies, and methods can allow for affixing a ring to pipe elements in a manner that reduces or excludes the likelihood of excess weld filler material from protruding beyond the end faces of the pipe elements to be joined. Accordingly, it is contemplated that the disclosed rings, assemblies, and methods can eliminate the need for post-welding grinding operations, thereby avoiding the timing, safety, and effectiveness problems associated with such operations.

### Ring and Assembly

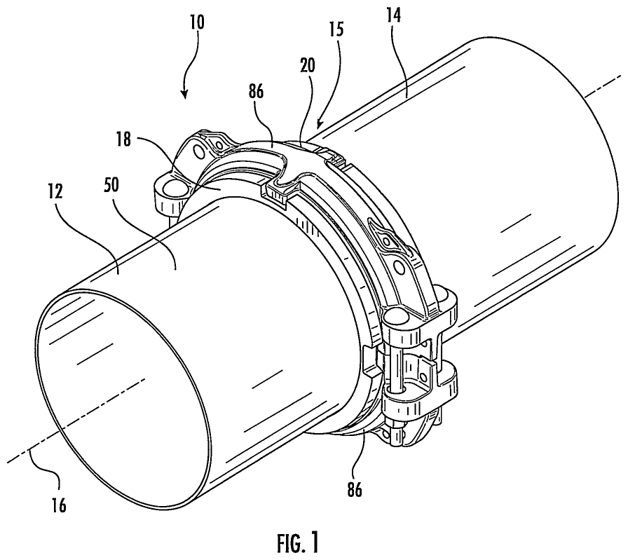

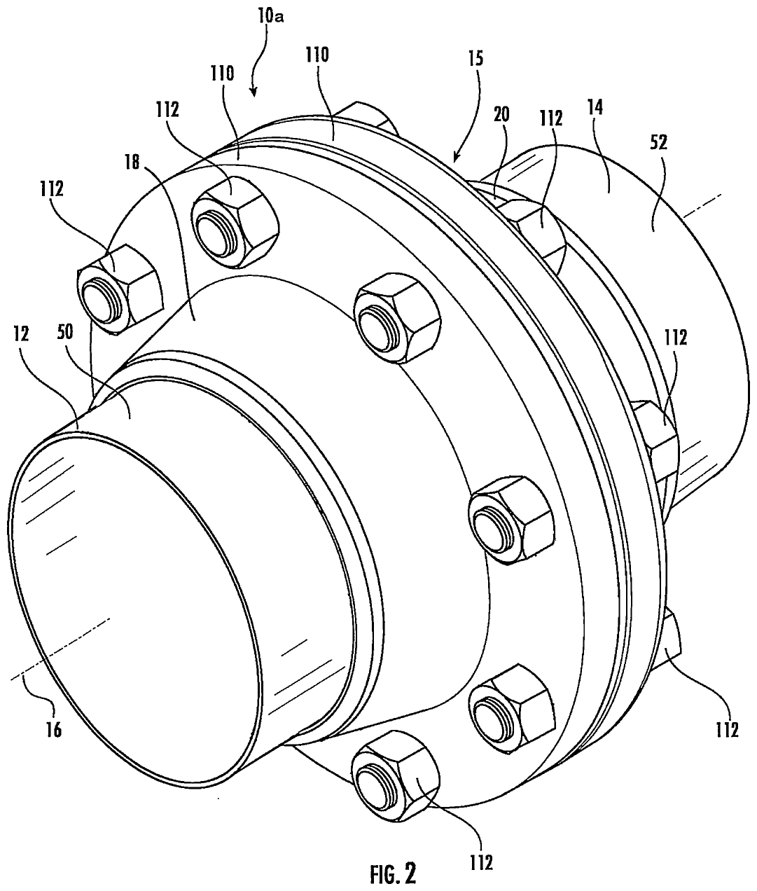

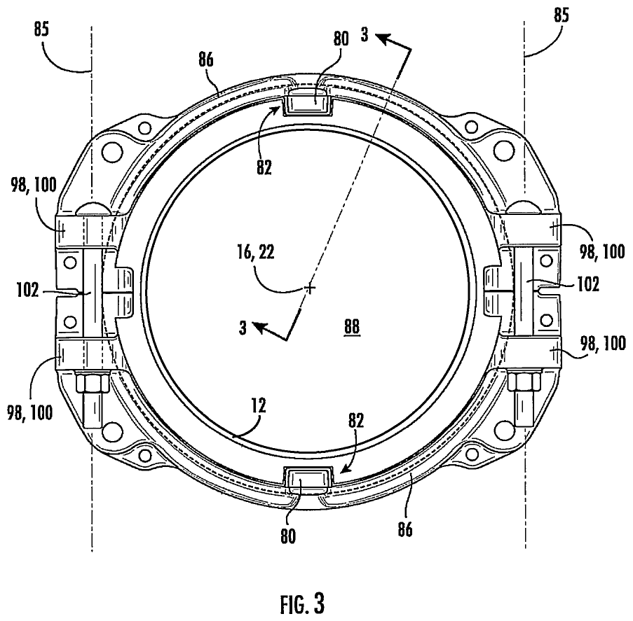

FIGS. 1 and 2 show example assemblies 10 and 10a for joining first and second pipe elements 12 and 14. Pipe element as used herein may be understood to mean any pipeline component including, for example, pipes, portions of pipe, fittings (such as, for example, elbow or tee fittings), valves, and other components. Each pipe element 12, 14 extends along a respective longitudinal axis 16. The assembly 10, 10a comprises a first ring 18 attachable to an end of the first pipe element 12. The assembly 10, 10a may comprise a second ring 20 attachable to an end of the second pipe element 14. More specifically, as shown in FIG. 3, the first ring 18 may be affixed to the outer surface 50 of the first pipe element. The second ring 20 may be affixed to the outer surface 52 of the second pipe element 14. While the figures and description of a ring as disclosed herein may be made with reference to the first ring 18 and pipe element 12, it is understood that the details and features described and shown for the first ring 18 may apply to the second ring 20 and pipe element 14.

As shown in FIG. 1, the assembly 10 may comprise a coupling 15 joining the first and second pipe elements 12, 14. As shown in FIGS. 1, 3, and 4, the coupling 15 may engage the rings 18, 20 to adjoin the pipe elements 12, 14 in facing engagement. The coupling 15 may comprise at least two segments 86, which are attachable end to end to surround a central space 88, configured to engage the rings 18, 20. As shown in FIG. 2, each segment 86 may comprise attachment members 98 positioned at opposite ends thereof. Attachment members 98 at respective ends may be engageable with each other. In the example embodiment, each attachment member 98 may comprise a lug 100 defining a hole. Each hole is adapted to receive an adjustable fastener 102 for attaching respective attachment members 98. As shown in FIG. 2, at least one adjustable fastener 102 may extend through respective attachment members 98 (e.g., one attachment member of the first segment and one attachment member of the second segment) along a fastener axis 85. Tightening of the adjustable fasteners 102 may draw the segments 86 together around the pipe elements 12, 14.

When the first and second rings 18, 20 are respectively affixed to the first and second pipe elements 12, 14, each ring 18, 20 is positioned coaxially with the respective pipe element 12, 14. As shown in FIG. 3, when the adjustable fasteners 102 are tightened to draw the segments 86 together to an installed condition (shown in FIGS. 1 and 3) the ends 17 of the pipe elements 12, 14 may abut one another when adjoined such that respective end faces 19 of the pipe elements 12, 14 engage. The end to end contact of the pipe elements 12, 14 may provide a smooth internal transition between pipe elements 12, 14 thereby minimizing turbulence and leading-edge wear.

As shown in FIG. 2, the assembly 10a may comprise a first ring 18 including a flange portion 110 as further described herein. The flange portion 110 may be coupled to another flanged pipe element. For example, as shown in FIG. 2, the flange portion 110 of the first ring 18 may be coupled to a flange portion 110 of the second ring 20. The flange portion 110 of the first ring 18 and the other flanged pipe element (optionally, the flange portion 110 of the second ring 20) may be coupled together via a plurality of adjustable fasteners 112 (e.g., adjustable (optionally, threaded) fasteners that extend through aligned holes defined within respective flange portions 110 of the first and second rings 18, 20). When the first and second rings 18, 20 are respectively affixed to the first and second pipe elements 12, 14, each ring 18, 20 is positioned coaxially with the respective pipe element 12, 14. When the adjustable fasteners 112 are tightened to draw the flange portions 110 together to an installed condition (shown in FIG. 2) the ends 17 of the pipe elements 12, 14 may abut one another when adjoined such that respective end faces 19 of the pipe elements 12, 14 engage. The end to end contact of the pipe elements 12, 14 may provide a smooth internal transition between pipe elements 12, 14 thereby minimizing turbulence and leading-edge wear.

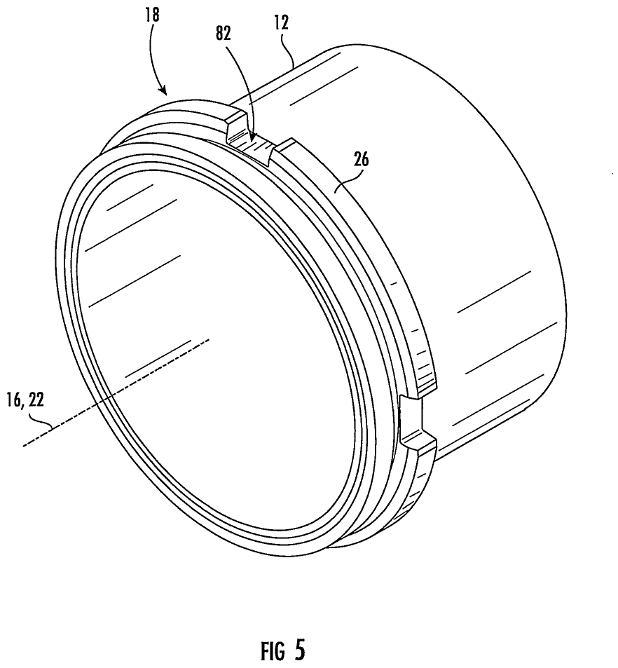

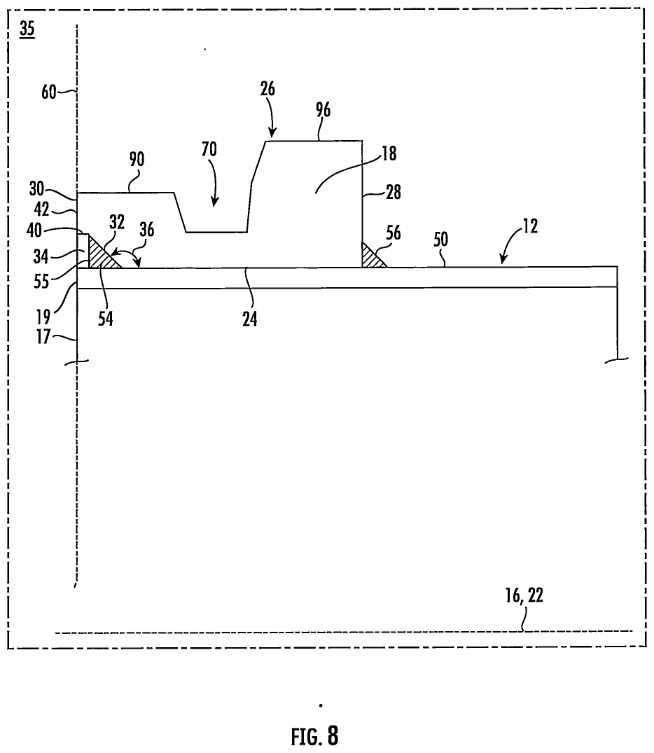

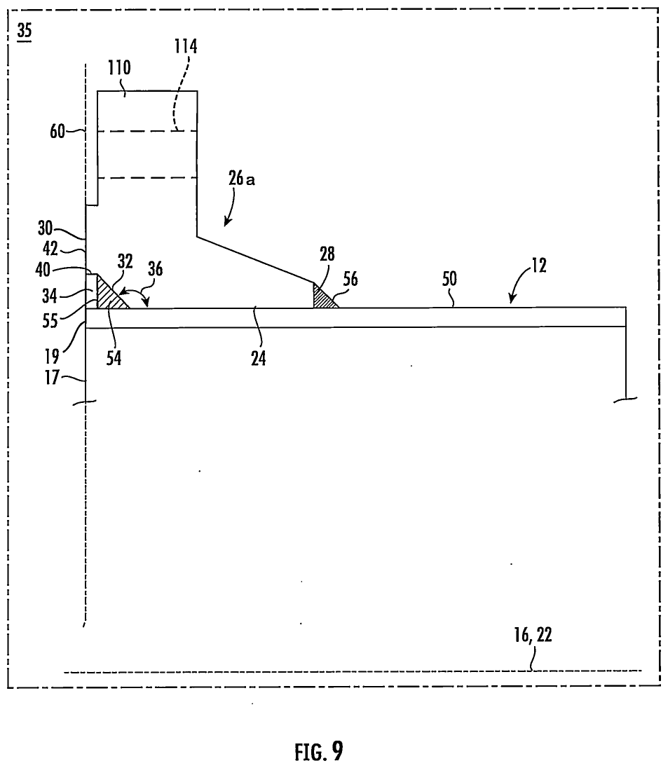

As shown in FIGS. 5-7, a ring 18 or 20 (the first ring 18 shown) or each ring surrounds a central axis 22, which may be aligned with the longitudinal axis 16 of the pipe element 12 or 14 (the first pipe element shown). As shown in FIGS. 8 and 9, the ring (the first ring 18 shown) comprises a circumferential outer surface 26, 26a and a circumferential inner surface 24. The circumferential outer surface 26, 26a faces away from the central axis 22. In this example embodiment, the second ring 20 may be identical to the first ring 18, and, as shown in FIG. 3, may comprise a circumferential inner surface 24 and a circumferential outer surface 26.

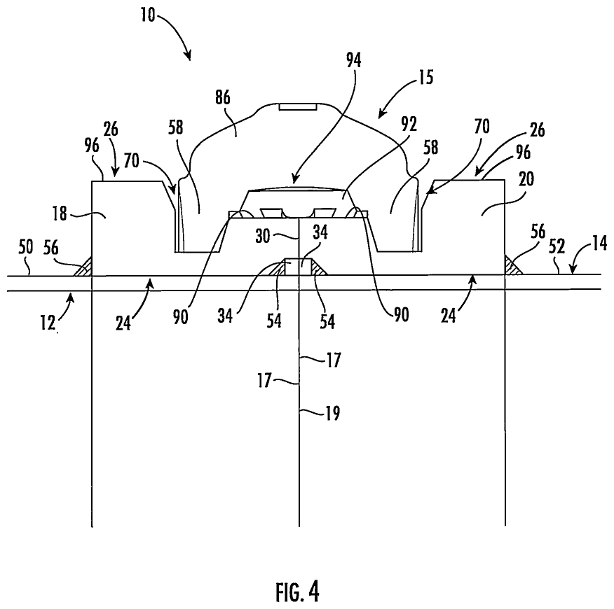

As shown in FIGS. 4 and 8, the circumferential outer surface 26 may define a groove 70 configured to receive an arcuate key 58 of the coupling 15. As shown in FIG. 4, the circumferential outer surface 26 of the second ring 20 may define a groove 70 configured to receive another arcuate key 58 of the coupling 15. The arcuate keys 58 may extend lengthwise along the segments 86 and be in spaced apart relation so as to engage the grooves 70 defined in the rings 18, 20. Engagement between the arcuate keys 58 of the coupling 15 and respective grooves 70 of the first and second rings 18, 20 may bring the pipe elements 12, 14, and optionally, the rings 18, 20 into end-to-end facing engagement.

The ring 18 or 20 disclosed herein may be used for various assemblies and/or various mechanical couplings. The ring 18 or 20 disclosed herein may be used in an assembly where it is desirable to prevent weld materials from creating a gap between pipe end faces 19. In an example embodiment, as shown in FIGS. 1 and 4, the assembly 10 may be a torsion resistant assembly configured to prevent the pipe elements 12, 14 from rotating with respect to one another about the longitudinal axes 16. To prevent rotation, the coupling 15 may comprise action surfaces, in this example defined by projections 80, that are configured to engage with receiving surface, in this example defined by notches 82, of the rings 18, 20. In this example, the circumferential outer surface 26 may define the receiving surfaces, in this example notches 82. Alternatively, the assembly may not be a torsion resistant assembly, and as shown in FIG. 5, the ring 18, and specifically, the circumferential outer surface 26 of the ring 18, may not include a receiving surface (for example, notches 82). For example, the ring can comprise a radial projection that extends circumferentially about the circumferential outer surface 26 of the ring and has a consistent radial dimension. Alternatively, the assembly may comprise a combination of different ring types. For example, the first ring 18 may be compatible with a torsion resistant assembly and the second ring 20 may not be compatible with a torsion resistant assembly. For example, the first ring 18 can be, or comprise features of, the ring shown in FIG. 4, and the second ring 20 can be, or comprise features of, the ring shown in FIG. 5. Although it is preferred to form a pipe joint using two rings as disclosed herein, it is contemplated that the rings 18, 20 disclosed herein can be used in combination with any other known ring type to form a pipe joint.

As shown in FIGS. 4 and 8, the circumferential outer surface 26 may comprise a sealing surface 90 configured to create a fluid-tight seal with a gasket 92. As shown in FIG. 4, the segments 86 may define a channel 94 positioned between the arcuate keys 58 configured to receive the gasket 92. The gasket 92 is engageable with the rings 18, 20, specifically the sealing surfaces 90, to effect a fluid-tight joint between the pipe elements 12, 14. The circumferential outer surface 26 of one or both rings may define a raised boss 96 configured to encourage effective engagement between the arcuate keys 58 and grooves 70 and to further secure the coupling 15. The raised boss 96 may be positioned on an opposite side of groove 70 from the sealing surface 90 and may optionally extend radially outward from the sealing surface 90.

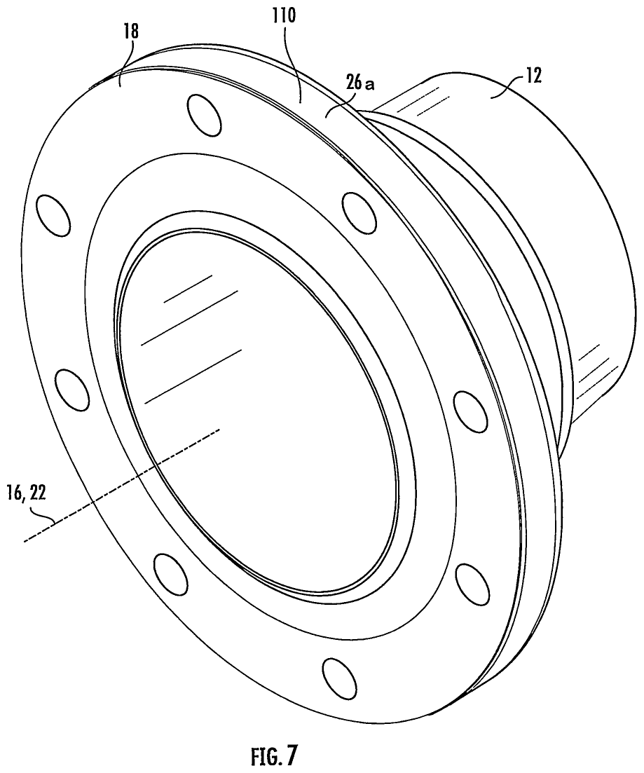

Alternatively, as shown in FIGS. 7 and 9, the circumferential outer surface 26a may comprise the flange portion 110. The flange portion 110 extends radially, outwardly away from the central axis 22. The flange portion 110 may be positioned radially outward of (e.g., may extend radially, outwardly away from) the remainder of the circumferential outer surface 26a. The flange portion 110 may be positioned radially outward of (e.g., may extend radially, outwardly away from) the remainder of the circumferential outer surface 26a such that the flange portion 110 has the largest diameter of the ring. The flange portion 110 may comprise a plurality of through holes 114. Each through hole 114 may be configured to receive an adjustable fastener 112 (shown in FIG. 2).

As shown in FIGS. 8 and 9, the circumferential inner surface 24 faces the central axis 22 and is adapted to receive a pipe element (first pipe element 12 shown). A backwall 28 extends between the circumferential inner surface 24 and the circumferential outer surface 26. A forward face 30 extends between the circumferential inner surface 24 and the circumferential outer surface 26. The forward face 30 is spaced from the backwall 28 along the central axis 22. The forward face 30 is closer to the end 17 of the pipe element (first pipe element 12 shown) than the backwall 28 is to the end 17 of the pipe element. That is, a spacing between the forward face 30 and the end 17 of the pipe element (first pipe element 12 shown) is less than a spacing between the backwall 28 and the end 17 of the pipe element.

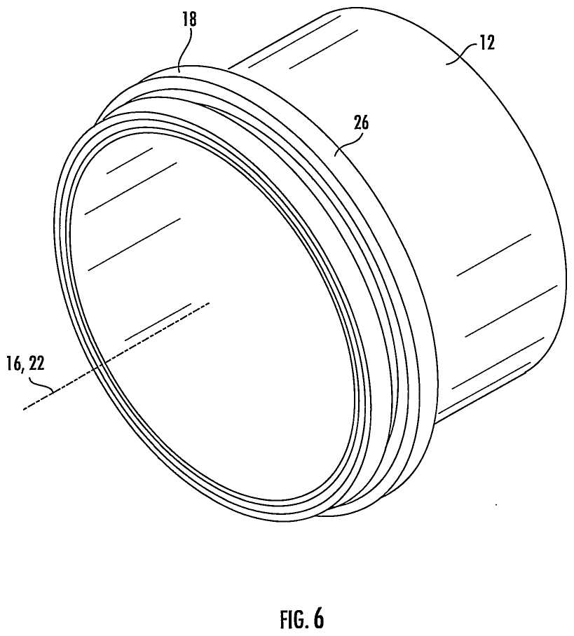

As shown in FIGS. 8 and 9, the forward face 30 comprises a sloped surface 32. The sloped surface 32 at least partially defines a pocket 34 within the forward face 30 to provide a welding space. A first weld 54 may be positioned within the pocket 34 of the forward face 30 of the ring 18 to affix the ring 18 to the outer surface 50 of the pipe element 12. Advantageously, the pocket 34 provides a welding surface and a space for the first weld 54 to reside such that weld filler material will not extrude, or is less likely to extrude, axially beyond the end face 19 of the pipe element 12 and/or the forward face 30 of the ring 18. The first weld 54 may have an exterior surface 55 that is positioned within the pocket 34 and does not extend beyond the forward face 30 such that the first weld 54 is fully contained within the pocket 34. For example, the exterior surface 55 of the first weld 54 may be axially spaced from the forward face 30 adjacent to the pocket 34. As shown in FIG. 6, in a cross-sectional plane 35 including the central axis 22, the sloped surface 32 extends away from the circumferential inner surface 24 at an obtuse angle 36. The obtuse angle 36 extends through the ring 18. That is, the obtuse angle 36 is measured between the circumferential inner surface 24 and the sloped surface 32, through the body of the ring as shown in FIG. 6 (rather than being measured moving away from the body of the ring). Optionally, the obtuse angle 36 is between 110° and 160°. Optionally, the obtuse angle 36 is between 120° and 150°. Optionally, the obtuse angle 36 is between 130° and 140°. Optionally, the obtuse angle 36 is 135° or is about 135° to advantageously provide a weld receiving space adjacent or under the sloped surface 32 that is as deep as the receiving space is tall. In the cross-sectional plane 35, the circumferential inner surface 24 may extend parallel or substantially parallel (for example, within 10° of parallel) to the central axis 22.

Optionally, the forward face 30 may further comprise a first side surface 40. The first side surface 40 and the sloped surface 32, together, may define the pocket 34 within the forward face 30. The first side surface 40 may create a larger receiving space for the first weld 54 thereby further preventing weld filler material from extruding axially beyond the end face 19 of the pipe element 12. In the cross-sectional plane 35, the first side surface 40 may extend parallel or substantially parallel (for example, within 10° of parallel) to the central axis 22. Optionally, the first side surface 40 is up to about 0.25 inch long in a direction parallel or substantially parallel (for example, within 10° of parallel) to the central axis 22. Optionally, the first side surface 40 is about 0.1875 inch long in a direction parallel or substantially parallel (for example, within 10° of parallel) to the central axis 22. Optionally, the first side surface 40 may have a length extending parallel or substantially parallel (for example, within 10° of parallel) to the central axis 22 that is about 40% of a weld length of a weld positioned in the pocket 34. The first side surface 40 may be contiguous with the sloped surface 32. It is understood that any surface or face disclosed herein may optionally comprise a rounded portion (for example, a concave or convex portion) or chamfered portion where the surface or face joins another surface or face. For example, the first side surface 40 may optionally comprise a concave portion where the first side surface 40 joins the sloped surface 32.

As shown in FIGS. 8 and 9, a portion 42 of the forward face 30 may extend perpendicularly or substantially perpendicularly (for example, within 10° of perpendicular) to the central axis 22. The portion 42 of the forward face 30 may be contiguous with the first side surface 40. Thus, as shown in FIGS. 8 and 9, the first side surface 40 can extend between the portion 42 of the forward face 30 and the sloped surface 32. The portion 42 of the forward face 30 may be contiguous with the circumferential outer surface 26. As shown, the portion 42 may extend radially outwardly from the first side surface 40 to the circumferential outer surface 26 (optionally, the sealing surface 90). The ring 18 may be positioned and affixed to the outer surface 50 of the pipe element 12 such that the portion 42 of the forward face 30 and the end face 19 of the pipe element 12 are aligned along a plane 60 that is perpendicular or substantially perpendicular (for example, within 5° of perpendicular) to the longitudinal axis 16 of the pipe element 12 and/or the central axis 22 of the ring. As shown in FIGS. 8 and 9, the exterior surface 55 of the first weld 54 may be positioned within the pocket 34. The exterior surface 55 of the first weld 54 may not extend axially beyond the portion 42 of the forward face 30. For example, the first side surface 40 and/or the sloped surface 32 may wholly overlie the first weld 54. The exterior surface 55 of the first weld 54 may not extend axially beyond the end face 19 of the pipe element. The exterior surface 55 of the first weld 54 may not extend axially beyond plane 60. Optionally, the exterior surface 44 of the first weld 54 may be axially spaced from the portion 42 of the forward face 30. Optionally, the exterior surface 55 of the first weld 54 may be axially spaced from the end face 19 of the pipe element. Optionally, the exterior surface 55 of the first weld 54 may be axially spaced from plane 60. In each of these examples, it is contemplated that the first weld 54 can be shaped and positioned to avoid contact between the weld material and the surface defining the end face 19 of the pipe element. Thus, the need for grinding of weld material or other modification to the end face of the pipe element can be avoided, leading to faster and safer joint formation.

As shown in FIGS. 8 and 9, the backwall 28 may extend perpendicularly or substantially perpendicularly (for example, within 10° of perpendicular) to the central axis 22. The backwall 28 may extend from the circumferential outer surface 26 to the circumferential inner surface 24. A second weld 56 may be positioned along the backwall 28 of the ring 18 to affix the ring 18 to the outer surface 50 of the pipe element 12.

### Method of Assembly

A method of affixing a ring (e.g., ring 18 or ring 20) to an end of a pipe element (e.g., pipe element 12 or 14) is disclosed herein. The ring (e.g., ring 18 or ring 20) may comprise any or all of the details and features as described herein. The method comprises welding the ring to the outer surface (e.g., outer surface 50 or outer surface 52) of the pipe element (e.g., pipe element 12 or pipe element 14) within the pocket 34 of the ring. More specifically, the sloped surface 32 of the forward face 30 defining the pocket 34 may be welded to the outer surface 50 of the pipe element 12. For example, welding material (e.g., filler material and/or a welding rod) may be positioned within the pocket 34. Optionally, the first side surface 40 may be welded to the outer surface 50 of the pipe element 12. Welding the ring 18 to the outer surface 50 of the pipe element 12 within the pocket 34 may enable the ring 18 to be affixed to the pipe element 12 without weld filler material protruding axially beyond the forward face 30 of the ring 18. The method may comprise aligning the portion 42 of the forward face 30 with the end face 19 of the pipe element 12 along the plane 60 that is perpendicular or substantially perpendicular (for example, within 5° of perpendicular) to the longitudinal axis 16 of the pipe element 12 and/or the central axis 22 of the ring. The method may comprise welding the backwall 28 to the outer surface 50 of the pipe element 12.

It is expected that the example ring, the assembly including the ring, and corresponding methods as disclosed herein may allow the ring to be affixed to the end of a pipe element via a weld while reducing or eliminating the likelihood of excess weld filler material protruding beyond the end faces of the pipe element and/or ring. It is expected that the example ring, assembly including the ring, and corresponding methods may allow pipe elements to which the rings are affixed to be brought together with zero or minimal gap between the end faces of the pipe elements and/or rings while also reducing or eliminating the need for powered grinders to be used to remove excess protruding weld filler material.

### EXEMPLARY ASPECTS

In view of the described device, systems, and methods and variations thereof, herein below are described certain more particularly described aspects of the invention. These particularly recited aspects should not however be interpreted to have any limiting effect on any different claims containing different or more general teachings described herein, or that the “particular” aspects are somehow limited in some way other than the inherent meanings of the language literally used therein.

Aspect 1: A ring surrounding a central axis and attachable to an end of a pipe element, the ring comprising:
a circumferential inner surface facing the central axis and adapted to receive the pipe element;
a circumferential outer surface facing away from the central axis;
a backwall extending between the circumferential inner surface and the circumferential outer surface; and
a forward face extending between the circumferential inner surface and the circumferential outer surface, the forward face being spaced from the backwall along the central axis, the forward face being closer to the end of the pipe element than the backwall is to the end of the pipe element, the forward face comprising a first side surface and a sloped surface positioned between the first side surface and the circumferential inner surface, the first side surface and the sloped surface defining a pocket within the forward face,
wherein, in a cross-sectional plane including the central axis, the sloped surface extends away from the circumferential inner surface at an obtuse angle, wherein the obtuse angle extends through the ring.

Aspect 2: The ring according to aspect 1, wherein in the cross-sectional plane, the first side surface extends parallel or substantially parallel to the central axis.

Aspect 3: The ring according to aspect 1 or aspect 2, wherein the first side surface is contiguous with the sloped surface.

Aspect 4: The ring according to any of the preceding aspects, wherein a portion of the forward face extends perpendicularly or substantially perpendicularly to the central axis.

Aspect 5: The ring according to aspect 4, wherein the portion of the forward face is contiguous with the first side surface.

Aspect 6: The ring according to aspect 4 or aspect 5, wherein the portion of the forward face is contiguous with the circumferential outer surface.

Aspect 7: The ring according to any of the preceding aspects, wherein the backwall extends from the circumferential outer surface to the circumferential inner surface.

Aspect 8: The ring according to aspect 7, wherein the backwall extends perpendicularly or substantially perpendicularly to the central axis.

Aspect 9: The ring according to any of the preceding aspects, wherein, in the cross-sectional plane, the circumferential inner surface extends parallel or substantially parallel to the central axis.

Aspect 10: The ring according to any of the preceding aspects, wherein the obtuse angle is between 110° and 160°.

Aspect 11: The ring according to any of the preceding aspects, wherein the obtuse angle is between 120° and 150°.

Aspect 12: The ring according to any of the preceding aspects, wherein the obtuse angle is between 130° and 140°.

Aspect 13: The ring according to any of the preceding aspects, wherein the obtuse angle is or is about 135°.

Aspect 14: The ring according to any of the preceding aspects, wherein the circumferential outer surface defines a groove configured to receive an arcuate key of a coupling.

Aspect 15: The ring according to any of the preceding aspects, wherein the circumferential outer surface comprises a flange portion configured to interface with another flange.

Aspect 16: In combination, a ring surrounding a central axis and a pipe element, the pipe element extending along a longitudinal axis and comprising an inner surface facing the longitudinal axis and an outer surface facing away from the longitudinal axis, the ring comprising:
a circumferential inner surface facing the central axis and adapted to receive the pipe element;
a circumferential outer surface facing away from the central axis;
a backwall extending between the circumferential inner surface and the circumferential outer surface; and
a forward face extending between the circumferential inner surface and the circumferential outer surface, the forward face being spaced from the backwall along the central axis, the forward face being closer to the end of the pipe element than the backwall is to the end of the pipe element, the forward face comprising a first side surface and a sloped surface positioned between the first side surface and the circumferential inner surface, the first side surface and the sloped surface defining a pocket within the forward face,
wherein, in a cross-sectional plane including the central axis, the sloped surface extends away from the circumferential inner surface at an obtuse angle, wherein the obtuse angle extends through the ring.

Aspect 17: The combination according to aspect 16, wherein in the cross-sectional plane, the first side surface extends parallel or substantially parallel to the central axis.

Aspect 18: The combination according to aspect 16 or aspect 17, wherein the first side surface is contiguous with the sloped surface.

Aspect 19: The combination according to any of aspects 16-18, wherein a portion of the forward face extends perpendicularly or substantially perpendicularly to the central axis.

Aspect 20: The combination according to aspect 19, wherein the portion of the forward face is contiguous with the first side surface.

Aspect 21: The combination according to aspect 19 or aspect 20, wherein the portion of the forward face is contiguous with circumferential outer surface.

Aspect 22: The combination according to any of aspects 16-21, wherein the backwall extends from the circumferential outer surface to the circumferential inner surface.

Aspect 23: The combination according to any of aspects 16-22, wherein the backwall extends perpendicularly or substantially perpendicularly to the central axis.

Aspect 24: The combination according to any of aspects 16-23, wherein, in the cross-sectional plane, the circumferential inner surface extends parallel or substantially parallel to the central axis.

Aspect 25: The combination according to any of aspects 16-24, wherein the obtuse angle is between 110° and 160°.

Aspect 26: The combination according to any of aspects 16-25, wherein the obtuse angle is between 120° and 150°.

Aspect 27: The combination according to any of aspects 16-26, wherein the obtuse angle is between 130° and 140°.

Aspect 28: The combination according to any of aspects 16-27, wherein the obtuse angle is or is about 135°.

Aspect 29: The combination according to aspect any of aspects 16-28, wherein the ring is affixed to the outer surface of the pipe element such that the ring is positioned coaxially with the pipe element.

Aspect 30: The combination according to aspect 29 further comprising a first weld positioned within the pocket of the forward face of the ring to affix the ring to the outer surface of the pipe element.

Aspect 31: The combination according to aspect 30 further comprising a second weld positioned along the backwall of the ring to affix the ring to the outer surface of the pipe element.

Aspect 32: The combination according to any of aspects 16-31, wherein the pipe element comprises an end having an end face.

Aspect 33: The combination according to aspect 32, wherein a portion of the forward face extends perpendicularly or substantially perpendicularly to the central axis, wherein the portion of the forward face and the end face of the pipe element are aligned along a plane perpendicular or substantially perpendicular to the longitudinal axis.

Aspect 34: The combination according to any of aspects 16-33, wherein the circumferential outer surface defines a groove configured to receive an arcuate key of a coupling.

Aspect 35: The combination according to any of aspects 16-34, wherein the circumferential outer surface comprises a flange portion configured to interface with another flange.

Aspect 36: An assembly for joining a first pipe element and a second pipe element in facing end to end relation, the assembly comprising: a coupling comprising first and second segments attachable end to end to surround a central space, wherein each segment of the first and second segments comprise at least one arcuate key extending into the central space; and at least one ring according to the ring of aspect 14, the at least one ring being attachable to an end of the first pipe element, wherein the groove is configured to receive a first arcuate key of the at least one arcuate key of each segment of the coupling

Aspect 37: The assembly according to aspect 36, wherein the at least one ring further comprises a second ring, wherein the second ring is attachable to an end of the second pipe element, wherein the groove of the second ring is configured to receive a second arcuate key of the at least one arcuate key of each segment of the coupling.

Aspect 38: The assembly according to aspect 37, wherein the circumferential outer surface of the first ring comprises at least one receiving surface configured to engage with at least one action surface of the coupling to prevent rotation of the first pipe element about the central axis of the first ring with respect to the coupling.

Aspect 39: The assembly according to aspect 38, wherein the circumferential outer surface of the first ring comprises at least one notch, wherein the at least one notch of the first ring comprises the at least one receiving surface of the first ring, wherein the coupling comprises at least one projection, wherein at least one projection comprises the at least one action surface, wherein each notch of the at least one notch of the first ring is configured to receive a respective projection of the at least one projection.

Aspect 40: The assembly according to aspect 37, wherein the circumferential outer surface of the second ring comprises at least one receiving surface configured to engage with at least one action surface of the coupling to prevent rotation of the second pipe element about the central axis of the second ring with respect to the coupling.

Aspect 41: The assembly according to aspect 40, wherein the circumferential outer surface of the second ring comprises at least one notch, wherein the at least one notch of the second ring comprises the at least one receiving surface of the second ring, wherein the coupling comprises at least one projection, wherein at least one projection comprises the at least one action surface, wherein each notch of the at least one notch of the second ring is configured to receive a respective projection of the at least one projection.

Aspect 42: A method of affixing a ring surrounding a central axis to an end of a pipe element, the pipe element extending along a longitudinal axis and comprising an inner surface facing the longitudinal axis and an outer surface facing away from the longitudinal axis, the ring comprising:
a circumferential inner surface facing the central axis and adapted to receive the pipe element;
a circumferential outer surface facing away from the central axis;
a backwall extending between the inner surface and the outer surface; and
a forward face extending between the inner surface and the outer surface, the forward face being spaced from the backwall along the central axis, the forward face being closer to the end of the pipe element than the backwall is to the end of the pipe element, the forward face comprising a first side surface and a sloped surface positioned between the first side surface and the circumferential inner surface, the first side surface and the sloped surface defining a pocket within the forward face, the method comprising:

welding the ring to the outer surface of the pipe element within the pocket.

Aspect 43: An assembly for joining a first pipe element and a second pipe element in facing end to end relation, the assembly comprising: first and second rings according to aspect 15, wherein the flange portion of the first ring is configured to couple to the flange portion of the second ring.

What is claimed is:

1. A ring surrounding a central axis and attachable to an end of a pipe element, said ring comprising:
a circumferential inner surface facing said central axis and adapted to receive said pipe element;
a circumferential outer surface facing away from said central axis;
a backwall extending between said circumferential inner surface and said circumferential outer surface; and
a forward face extending between said circumferential inner surface and said circumferential outer surface, said forward face being spaced from said backwall along said central axis, said forward face being closer to said end of said pipe element than said backwall is to said end of said pipe element, said forward face comprising a first side surface and a sloped surface positioned between said first side surface and said circumferential inner surface, said first side surface and said sloped surface defining a pocket within said forward face,
wherein, in a cross-sectional plane including said central axis, said sloped surface extends away from the circumferential inner surface at an obtuse angle, wherein said obtuse angle extends through said ring.

2. The ring according to claim 1, wherein in said cross-sectional plane, said first side surface extends parallel or substantially parallel to said central axis.

3. The ring according to claim 1, wherein said first side surface is contiguous with said sloped surface.

4. The ring according to claim 1, wherein a portion of said forward face extends perpendicularly or substantially perpendicularly to said central axis.

5. The ring according to claim 4, wherein said portion of said forward face is contiguous with said first side surface.

6. The ring according to claim 4, wherein said portion of said forward face is contiguous with said circumferential outer surface.

7. The ring according to claim 1, wherein said backwall extends from said circumferential outer surface to said circumferential inner surface.

8. The ring according to claim 7, wherein said backwall extends perpendicularly or substantially perpendicularly to said central axis.

9. The ring according to claim 1, wherein, in said cross-sectional plane, said circumferential inner surface extends parallel or substantially parallel to said central axis.

10. The ring according to claim 1, wherein said obtuse angle is between 110° and 160°.

11. The ring according to claim 1, wherein said obtuse angle is between 120° and 150°.

12. The ring according to claim 1, wherein said obtuse angle is between 130° and 140°.

13. The ring according to claim 1, wherein said obtuse angle is or is about 135°.

14. The ring according to claim 1, wherein said circumferential outer surface defines a groove configured to receive an arcuate key of a coupling.

15. The ring according to claim 1, wherein said circumferential outer surface comprises a flange portion configured to interface with another flange.

16. In combination, a ring surrounding a central axis and a pipe element, said pipe element extending along a longitudinal axis and comprising an inner surface facing said longitudinal axis and an outer surface facing away from said longitudinal axis, said ring comprising:
a circumferential inner surface facing said central axis and adapted to receive said pipe element;
a circumferential outer surface facing away from said central axis;
a backwall extending between said circumferential inner surface and said circumferential outer surface; and
a forward face extending between said circumferential inner surface and said circumferential outer surface, said forward face being spaced from said backwall along said central axis, said forward face being closer to said end of said pipe element than said backwall is to said end of said pipe element, said forward face comprising a first side surface and a sloped surface positioned between said first side surface and said circumferential inner surface, said first side surface and said sloped surface defining a pocket within said forward face,
wherein, in a cross-sectional plane including said central axis, said sloped surface extends away from the circumferential inner surface at an obtuse angle, wherein said obtuse angle extends through said ring.

17. The combination according to claim 16, wherein in said cross-sectional plane, said first side surface extends parallel or substantially parallel to said central axis.

18. The combination according to claim 16, wherein said first side surface is contiguous with said sloped surface.

19. The combination according to claim 16, wherein a portion of said forward face extends perpendicularly or substantially perpendicularly to said central axis.

20. The combination according to claim 19, wherein said portion of said forward face is contiguous with said first side surface.

21. The combination according to claim 19, wherein said portion of said forward face is contiguous with circumferential outer surface.

22. The combination according to claim 16, wherein said backwall extends from said circumferential outer surface to said circumferential inner surface.

23. The combination according to claim 22, wherein said backwall extends perpendicularly or substantially perpendicularly to said central axis.

24. The combination according to claim 16, wherein, in said cross-sectional plane, said circumferential inner surface extends parallel or substantially parallel to said central axis.

25. The combination according to claim 16, wherein said obtuse angle is between 110° and 160°.

26. The combination according to claim 16, wherein said obtuse angle is between 120° and 150°.

27. The combination according to claim 16, wherein said obtuse angle is between 130° and 140°.

28. The combination according to claim 16, wherein said obtuse angle is or is about 135°.

29. The combination according to claim 16, wherein said ring is affixed to said outer surface of said pipe element such that said ring is positioned coaxially with said pipe element.

30. The combination according to claim 29 further comprising a first weld positioned within said pocket of said forward face of said ring to affix said ring to said outer surface of said pipe element.

31. The combination according to claim 30 further comprising a second weld positioned along said backwall of said ring to affix said ring to said outer surface of said pipe element.

32. The combination according to claim 16, wherein said pipe element comprises an end having an end face.

33. The combination according to claim 32, wherein a portion of said forward face extends perpendicularly or substantially perpendicularly to said central axis, wherein said portion of said forward face and said end face of said pipe element are aligned along a plane perpendicular or substantially perpendicular to said longitudinal axis.

34. The combination according to claim 16, wherein said circumferential outer surface defines a groove configured to receive an arcuate key of a coupling.

35. The combination according to claim 16, wherein said circumferential outer surface comprises a flange portion configured to interface with another flange.

36. An assembly for joining a first pipe element and a second pipe element in facing end to end relation, said assembly comprising:
a coupling comprising first and second segments attachable end to end to surround a central space, wherein each segment of said first and second segments comprise at least one arcuate key extending into said central space; and
at least one ring according to the ring of claim 14, said at least one ring being attachable to an end of said first pipe element, wherein said groove is configured to receive a first arcuate key of said at least one arcuate key of each segment of said coupling

37. The assembly according to claim 36, wherein said at least one ring further comprises a second ring, wherein said second ring is attachable to an end of said second pipe element, wherein said groove of said second ring is configured to receive a second arcuate key of said at least one arcuate key of each segment of said coupling.

38. The assembly according to claim 37, wherein said circumferential outer surface of said first ring comprises at least one receiving surface configured to engage with at least one action surface of said coupling to prevent rotation of said first pipe element about said central axis of said first ring with respect to said coupling.

39. The assembly according to claim 38, wherein said circumferential outer surface of said first ring comprises at least one notch, wherein said at least one notch of said first ring comprises said at least one receiving surface of said first ring, wherein said coupling comprises at least one projection, wherein at least one projection comprises said at least one action surface, wherein each notch of said at least one notch of said first ring is configured to receive a respective projection of said at least one projection.

40. The assembly according to claim 37, wherein said circumferential outer surface of said second ring comprises at least one receiving surface configured to engage with at least one action surface of said coupling to prevent rotation of said second pipe element about said central axis of said second ring with respect to said coupling.

41. The assembly according to claim 40, wherein said circumferential outer surface of said second ring comprises at least one notch, wherein said at least one notch of said second ring comprises said at least one receiving surface of said second ring, wherein said coupling comprises at least one projection, wherein at least one projection comprises said at least one action surface, wherein each notch of said at least one notch of said second ring is configured to receive a respective projection of said at least one projection.

42. A method of affixing a ring surrounding a central axis to an end of a pipe element, said pipe element extending along a longitudinal axis and comprising an inner surface facing said longitudinal axis and an outer surface facing away from said longitudinal axis, said ring comprising:
a circumferential inner surface facing said central axis and adapted to receive said pipe element;
a circumferential outer surface facing away from said central axis;
a backwall extending between said inner surface and said outer surface; and
a forward face extending between said inner surface and said outer surface, said forward face being spaced from said backwall along said central axis, said forward face being closer to said end of said pipe element than said backwall is to said end of said pipe element, said forward face comprising a first side surface and a sloped surface positioned between said first side surface and said circumferential inner surface, said first side surface and said sloped surface defining a pocket within said forward face, said method comprising:
welding said ring to said outer surface of said pipe element within said pocket.

43. An assembly for joining a first pipe element and a second pipe element in facing end to end relation, said assembly comprising:
first and second rings according to claim 15,
wherein said flange portion of said first ring is configured to couple to said flange portion of said second ring.
